(19) United States
(12) Patent Application Publication
(10) Pub. No.: US 2008/0207308 A1
(43) Pub. Date: Aug. 28, 2008

(54) Game system in which a plurality of players participate

(75) Inventor: Kazumasa Yoshizawa, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: ARUZE CORP., Tokyo (JP)

(21) Appl. No.: 12/010,416

(22) Filed: Jan. 24, 2008

(30) Foreign Application Priority Data
Jan. 25, 2007 (JP) 2007-015300

(51) Int. Cl. A63F 9/24; A63F 13/00

(52) U.S. Cl. 463/25

(57) ABSTRACT

A game system provides a game in which a plurality of players participate and includes: at least one camera device that captures facial images of the players; a plurality of display units that are provided for each of the players and display images related to the game; a plurality of input devices that are provided for each of the players and allow the respective players to input commands for playing the game; and a controller that operates to: control the camera device to capture facial images of all the players currently playing the game, when one of the players satisfies a predetermined condition in the game; and control all the display units, which are provided for the players currently playing the game, to display at least the facial images of the players other than the player who plays the game with the respective display units.

### CROSS-REFERENCE TO THE RELATED APPLICATION(S)

The present application is based upon and claims priority from prior Japanese Patent Application No. 2007-015300, filed on Jan. 25, 2007, the entire content of which are incorporated herein by reference.

### TECHNICAL FIELD

The present invention relates to a game system that provides a game in which a plurality of players participate.

### BACKGROUND

As a game system in which a plurality of players participate, which is called a multi-player game system, there is proposed a system that automate a game, such as Black Jack, Poker, Craps, Roulette, Baccarat, and Pai Gow Poker, while a plurality of players participate in the game consecutively or non-synchronously, so that information relating to advertising items can be exchanged between the players and an advertiser. An example of thus configured system is disclosed in WO-A1-97026061.

As another example of the multi-player game system, there is proposed a system that provides a tournament game, for example, by using an interactive communication system such as the Internet. In the system, a plurality of players play games against a host computer so as to acquire predetermined points, and players acquiring high level scores obtain awards. An example of thus configured system is disclosed in WO-A1-00071218.

As still another example of multi-player game systems, there is proposed a system that provides a positive payout (for example, performing a lottery using tokens and paying out on the basis of the result of the lottery) relating to gambles through a network. An example of thus configured system is disclosed in WO-A1-02041233.

Multi-player game systems in which a plurality of players plays a mass game such as a card game (for example, Poker) while viewing a same display have a limitation on the configuration thereof, when compared to a game system in which remote players simultaneously play a game. In other words, in a multi-player game system, generally, a large-size display that can be visually recognized from a plurality of players is disposed, and a plurality of stations are arranged in one row or in an arc shape so as to face the large-size display. Accordingly, all the players playing the game by using the stations can visually recognize the large-size display by disposing the plurality of stations, which are disposed in a horizontal arrangement or in an arc shape, to face the large-size display. In addition, since each station has an individual display, each player can recognize the situation of the whole game from the large-size display and recognize the player's own game state from the display disposed in the station for advancing the game.

When providing a card game, such as Poker, by the multi-player game system, for example, the cards dealt to each of the players and other information may be displayed in the displays provided in each of the stations while the video image of a dealer is displayed in the large-size display. By this configuration, it is possible to let the players have a feeling that the players play a game against the dealer.

However, when the large-size display and a plurality of stations are disposed as described above, the players can visually recognize the large-size display in an easy manner, but there is a problem that it is difficult for the players to recognize facial expressions of other players. In particular, in a card game, such as Poker, the player tactically plays the game by predicting psychological state of other players from their facial expressions, and the tactics have a great effect on winning the game. However, when the stations are disposed in a horizontal arrangement or in an arc shape, there is a problem that it is difficult for each player to recognize the facial expressions of other players. In addition, when the plurality of players located in the horizontal arrangement or in the arc shape try to check the facial expressions of other players, the players may give other players an unpleasant feeling, and thereby there is a possibility that the game cannot be smoothly advanced.

In view of the above-described problems, there is a demand for a multi-player game system that can provide a new entertaining feature by enabling each player to acquire other players' facial expressions easily and naturally.

### SUMMARY

One of objects of the present invention is to provide a game system that provides new entertaining feature that has not been proposed in the conventional art, which to enable each player to acquire other players' facial expressions easily and naturally.

According to one aspect of the invention, there is provided a game system that provides a game in which a plurality of players participate, the game system including: at least one camera device that captures facial images of the players; a plurality of display units that are provided for each of the players and display images related to the game; a plurality of input devices that are provided for each of the players and allow the respective players to input commands for playing the game; and a controller that operates to: control the camera device to capture facial images of all the players currently playing the game, when one of the players satisfies a predetermined condition in the game; and control all the display units, which are provided for the players currently playing the game, to display at least the facial images of the players other than the player who plays the game with the respective display units.

### BRIEF DESCRIPTION OF THE DRAWINGS

In the accompanying drawings:

FIG. 1 is a flowchart showing a camera process performed by a game system according to an embodiment of the present invention;

FIG. 2 is a schematic perspective view showing a game system according to an embodiment;

FIG. 3 is a top view showing a game system according to an embodiment;

FIG. 4 is a schematic perspective view of a station included in the game system according to the embodiment;

FIG. 5 is a diagram showing an example of an image displayed on a front display;

FIG. 6 is a diagram showing an example of an image displayed on a liquid crystal display of the station;

FIG. 7 is a diagram showing an example of an image displayed on a player display 80 of the station;

FIG. 8 is a block diagram showing the internal configuration of a game system according to the embodiment;

FIG. 9 is a block diagram showing the internal configuration of a station according to the embodiment;

FIG. 10 is a flowchart showing a game process according to the embodiment;

FIG. 11 is a flowchart showing a game process according to the embodiment;

FIG. 12 is a diagram showing an example of an image displayed on a front display included in the game system;

FIG. 13 is a top view showing an example of the game system;

FIG. 14 is a top view showing an example of the game system;

FIG. 15 is a perspective view showing an example of the game system; and

FIG. 16 is a perspective view showing an example of the game system.

### DETAILED DESCRIPTION

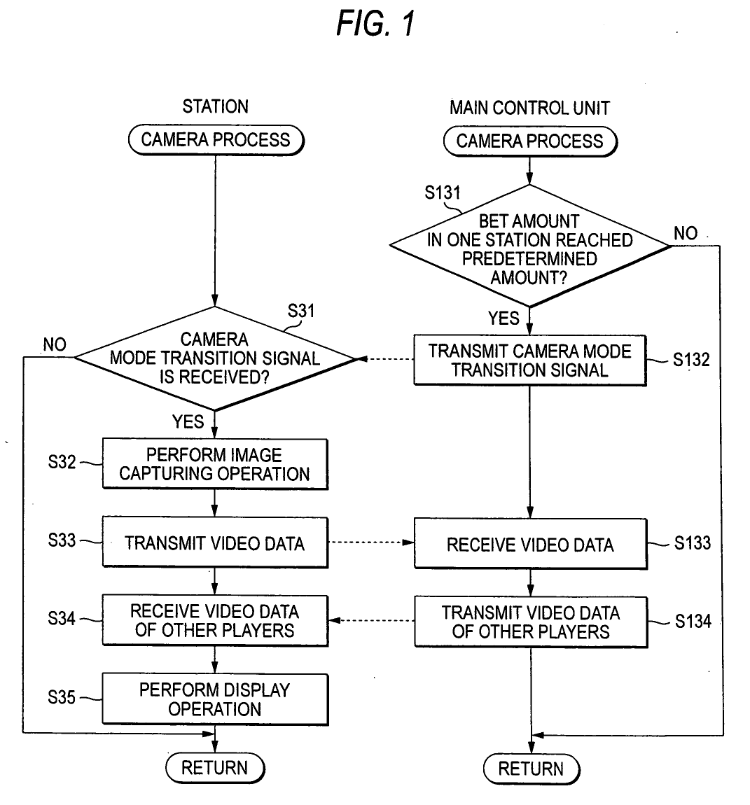

An embodiment of the present invention will now be described with reference to FIG. 1.

FIG. 1 is a flowchart showing a camera process performed by a game system according to an embodiment.

The camera process is a process for capturing an image of a player with a camera and displaying the captured image on a display.

The game system according to the embodiment includes a main control unit and a plurality of stations. Each station has a microcomputer. The main control unit and the microcomputer serve as a controller of the game system according to the present invention.

The process shown in FIG. 1 is a process cooperatively performed by the main control unit and the microcomputer, that is, a process performed by the controller of the game system according to the present invention.

First, when determining that a bet amount in one station has reached a predetermined amount (Step S131), the main control unit transmits a camera mode transition signal to all the stations (hereinafter, also referred to as each station) in which a game is played (Step S132). The camera mode transition signal is a signal used for indicating a direction for transition to a camera mode. The camera mode represents a state in which an operation for capturing an image of a player by the camera is performed and videos of the captured image of the players are displayed in a display.

When determining that a camera mode transition signal has been received (Step S31), each station performs an operation for capturing an image of a player by a camera (Step S32). Then, each station transmits video data acquired by the image capturing operation to the main control unit (Step S33).

When receiving the video data from each station (Step S133), the main control unit transmits the video data captured in other stations to each station in which the game is played (Step S134).

When receiving this video data (Step S34), each station displays the image captured by other stations in the display thereof (Step S35).

In the embodiment, a case where each station transmits the video data to the main control unit and the video data from each station is transmitted to other stations from the main control unit will be described. However, according to the present invention, a transmission path of the video data from each station to other stations is not particularly limited. For example, the video data may be configured to be transmitted from each station to other stations not through the main control unit.

FIG. 1 will be described again in detail, later.

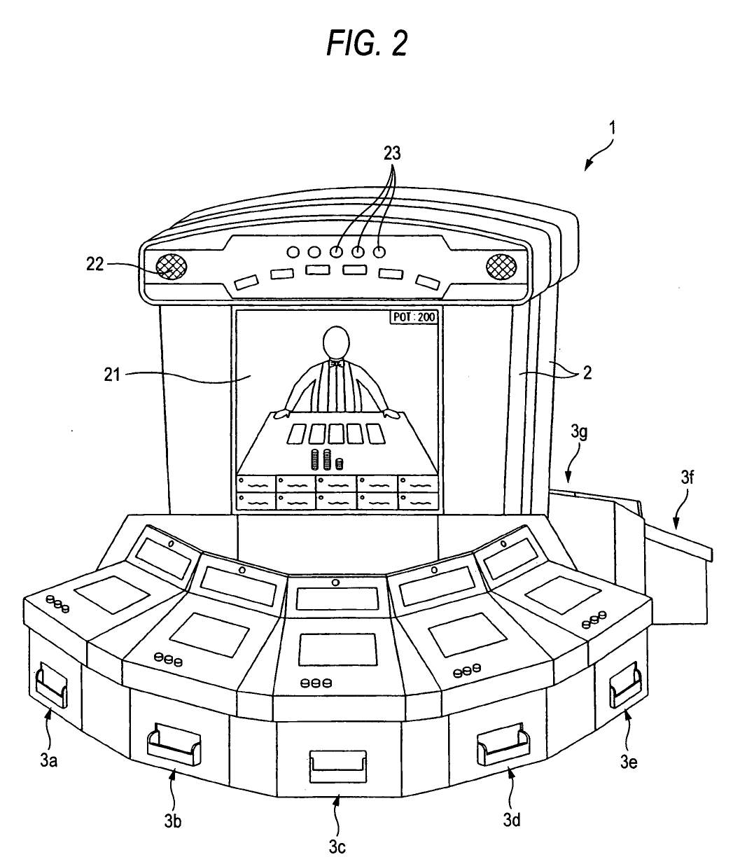

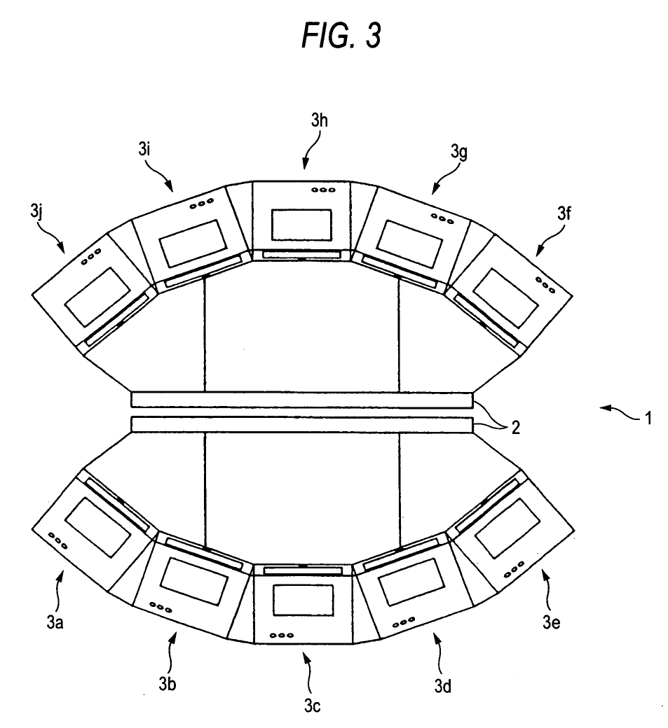

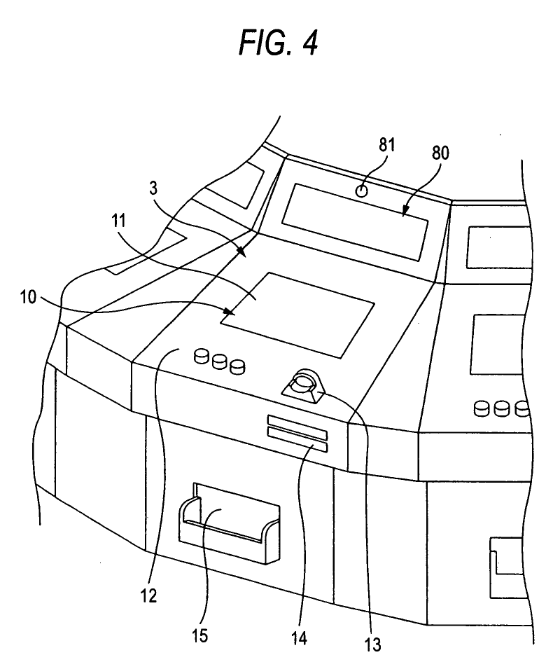

FIG. 2 is a schematic perspective view of a game system according to an embodiment. FIG. 3 is a top view of a game system according to an embodiment. FIG. 4 is a schematic perspective view of a station included in the game system according to the embodiment.

As shown in FIG. 2, two main displays 2 are disposed in back-to-back arrangement in a game system 1 according to the embodiment. Each main display 2 has a front display 21 on which an image of a dealer, game information of the players, and the like are displayed, speakers 22 that are disposed above the front display 21 and output music or effect sounds in accordance with progress of the game, and LEDs 23 that are turned on for providing various visual effects.

As shown in FIGS. 2 and 3, ten stations 3 (in a counter clockwise direction from the lower left end in FIG. 1, referred to as a station 3a, a station 3b, . . . , a station 3i, and a station 3j) are disposed to surround two main displays 2 of the game system 1.

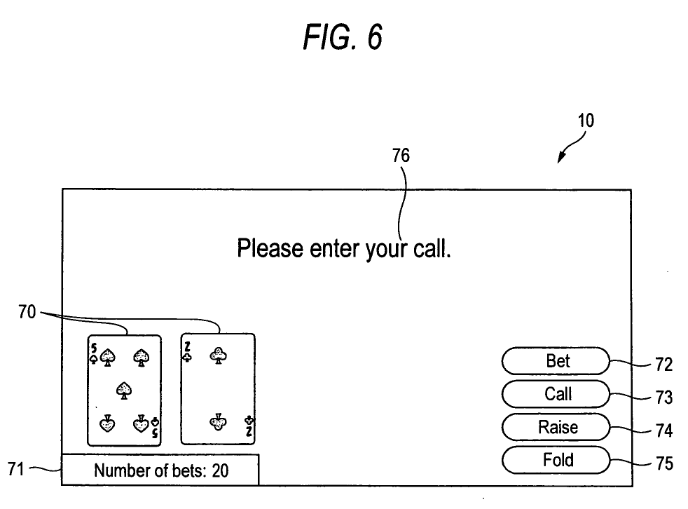

As shown in FIG. 4, in an approximate center of the upper portion of the station 3, a liquid crystal display 10 for displaying an image (see FIG. 6) relating to an operation, to be described later, the result of a game, or the like is disposed.

On an upper portion of the liquid crystal display 10, a touch panel 11 for a player to input an operation is disposed. The touch panel 11 serves as an input device according to the present invention. The input device according to the present invention is not particularly limited. For example, a conventionally known input device may be employed as the input device. In addition, according to the present invention, the position or method of installing the input device is not particularly limited and can be appropriately designed in accordance with the input device.

As shown in FIG. 4, the station 3 has a player display 80 in addition to the liquid crystal display 10. Above the player display 80, a camera 81 is disposed. When a predetermined condition is satisfied (in the embodiment, when a bet amount for one game in one station 3 reaches a predetermined amount), the camera 81 captures an image of the player. Then, the video of the captured image of the player is displayed on the player display 80. The player display 80 serves as a display unit according to the present invention.

In the embodiment, although the station 3 has two types of displays including the liquid crystal display 10 and the player display 80, however, the present invention is not limited thereto. The station 3 may be configured to have the liquid crystal display 10 only. In other words, the video image of the player captured by the camera 81 may be configured to be displayed on the liquid crystal display 10. In such a case, the liquid crystal display 10 serves as a display unit according to the present invention.

In the embodiment, as shown in FIG. 4, the camera 81 is disposed above the player display 80 in an exposed manner, and the existence of the camera may be noticed by the player at any time. However, the installation aspect of the camera according to the present invention is not limited thereto. For example, it may be configured that the camera is normally covered with a shutter or the like and appears to the sight of the player only in a case where a transition to the camera mode (to be described later) is made.

In the embodiment, although one camera 81 is configured to be provided in each station 3, the number of cameras arranged in the game system according to the present invention is not limited thereto. In other words, it is not necessarily required to arrange cameras for each of the stations. For example, only one camera 81 may be disposed on the main display 2 or the like, so that all the players are individually captured by the single camera 81. Furthermore, a plurality of cameras 81 may be disposed on the main display 2 or the like, so that all the players are individually captured by cooperation of the plurality of cameras 81. In other words, as long as all the players can be individually captured, the number and installed locations of the cameras 81 are not particularly limited.

As described above, in the embodiment, the station 3 has the camera 81 (a camera according to the present invention), the player display 80 (a display unit according to the present invention), and the touch panel 11 (an input device according to the present invention). As described above, the station according to the present invention has a camera, a display, and an input device and is used for a player's playing a game.

In front of the liquid crystal display 10, an operation button 12 for performing a payout operation and a coin insertion slot 13 for inserting a coin or medal is disposed.

In the upper right end of the front side of the station 3, a bill insertion slot 14 for inserting a bill is disposed. Below the bill insertion slot 14, a coin payout opening 15 for paying out a player coins or medals corresponding to stored credits in a case where a payout operation is performed is disposed.

In the game system 1 according to the embodiment, Hold'em Poker is performed as a game.

Here, the Hold'em Poker rule will be described.

In Hold'em Poker, one set (52 cards) of playing cards excluding Joker is used.

First, a dealer deals two cards to each player. Each player refers to the cards dealt to him and selects one behavior among betting chips (hereinafter, also abbreviated as “bet”), betting chips of the same amount as the former player (hereinafter, referred to as “call”) , raising the bet amount (hereinafter, also referred to as “raise”), and completing a game without placing a bet (hereinafter, also referred to as “fold”). Hereinafter, this selection is called as a selection of a bet (also referred to as a bet selection). The bet selection of each player here will be referred to as a dealing turn.

Next, the dealer opens three cards (called “Flop”) from among his holding cards. In the game system 1 according to the embodiment, the Flop is displayed on the front display 21, as described below. Here, each player performs a bet selection. The bet selection of each player here will be referred to as a turn of Flop.

Next, the dealer opens a fourth card (called “Turn”). Then, each player performs a bet selection. The bet selection of each player here will be referred to as a turn of Turn.

Next, the dealer opens a fifth card (called “River”). Then, each player performs a bet selection. The bet selection of each player here will be referred to as a turn of River.

Next, all the cards (cards dealt first) held by players remaining in the game are open (called Showdown), and each player makes a hand by combining two holding cards and three cards from among five cards of the dealer. All the bet chips are given to a player who has made the strongest hand by comparing the hands of the players.

Next, images displayed on the front display 21, the liquid crystal display 10, and the player display 80 during a game will be described.

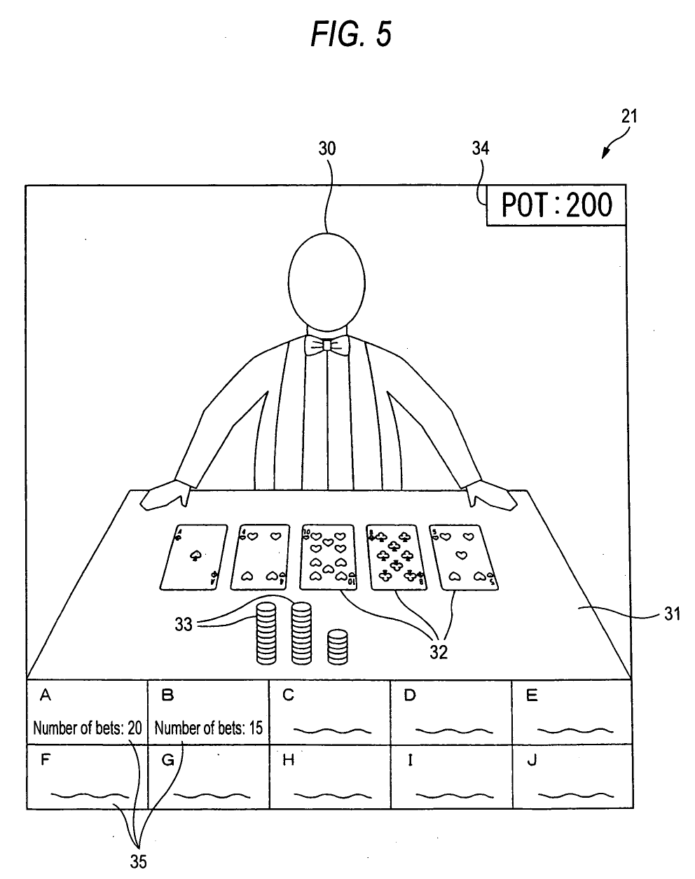

FIG. 5 is a diagram showing an example of an image displayed on the front display.

As shown in FIG. 5, in an approximate center of the front display 21, a dealer 30 is displayed.

Below the dealer 30, a table 31 is displayed. On the table 31, five card images 32 representing five cards and a chip image 33 representing bet chips are displayed.

In addition, below the table 31, game information display sections 35 in which game information of the players are displayed are arranged. Alphabets of A to J displayed in the game information display sections 35 correspond to stations 3a to 3j. In each game information display section 35, game information on the player using the corresponding station 3 is displayed.

The game information includes the current number of bets of each player and information on the bet selection. In addition, when a Showdown process is performed, cards dealt first to the players are displayed in the game information display sections 35.

When there is a station 3 that is not used for the game, the game information on a player who has a turn to perform a bet selection is configured to be displayed in the game information display section 35 corresponding to the station 3.

In the right end of the upper potion of the front display 21, a pot display section 34 for displaying the total amount of chips currently bet is arranged.

In the embodiment, an image displayed on one front display 21 between the front displays 21 of two main displays 2 is configured to be the same as an image displayed on the other front display 21.

FIG. 6 is a diagram showing an example of an image displayed on the liquid crystal display of the station.

As shown in FIG. 6, on the left side of the liquid crystal display 10, two card images 70 representing two cards dealt to the player at the start of the game are shown.

Below the card images 70, a bet display section 71 for displaying the current number of bets of the player is arranged.

On the right side of the liquid crystal display 10, a bet selection section 72 for selecting a “bet”, a call selection section 73 for selecting a “call”, a raise selection section 74 for selecting a “raise”, and a fold selection section 75 for selecting a “fold” are arranged for the bet selection. The player can perform the bet selection by touching a portion on the touch panel 11 corresponding to a selection section.

In addition, on the upper side of the liquid crystal display 10, a direction image 76 of “Please enter your call” for requesting the player to make a bet selection is displayed.

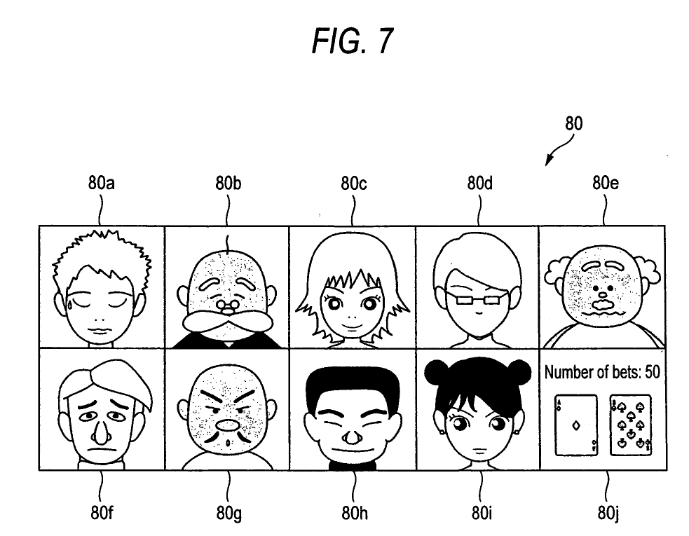

FIG. 7 is a diagram showing an example of an image displayed on the player display of the station.

As shown in FIG. 7, the player display 80 is divided into ten divisions (a player display section 80a, a player display section 80b, . . . , and a player display section 80j). The player display sections 80a to 80j correspond to the stations 3a to 3j. In each player display section 80a to 80j, the video image of a player playing the game using the corresponding station is displayed. However, as described later, in a player display section (in the example shown in FIG. 7, the player display section 80j) corresponding to the station 3 having the player display 80, the game information of the player playing the game using the station 3 is displayed.

In the embodiment, although the video images of the players are configured to be displayed in the player display 80, the location in which the video images of the players are displayed according to the present invention is not limited thereto. For example, as described above, it may be configured that only the liquid crystal display 10 is included in the station 3 as a display and the video images of the players are displayed in the liquid crystal display 10. In addition, even when the station 3 has the player display 80, the video images of the players may be configured to be displayed on both the liquid crystal display 10 and the player display 80. Furthermore, the video images of the players may be configured to be displayed on the front display 21. In such a case, on the display of the station 3, the video images of the players may be configured to be or not to be displayed.

As described above, when the station 3 includes the player display 80, it may be configured that the video images of the players are displayed on any one or two or more of the front display 21, the liquid crystal display 10, and the player display 80. On the other hand, when the station 3 dose not include the player display 80, the video images of the players may be configured to be displayed on any one or both of the front display 21 and the liquid crystal display 10. The one or two or more displays in which the video images of the players are displayed correspond to a display unit according to the present invention.

In the example shown in FIG. 7, in a total of nine player display sections excluding a player display section 80j corresponding to the station 3j having the player display 80 from among ten player display section, the video images of the players are displayed (see Step S35 shown in FIG. 1, described later). However, according to the present invention, the number (the number of players to be displayed) of the video images of the players displayed in the player display is not limited thereto. For example, it may be configured that the station 3 includes an input device for selecting a player whose video is to be displayed and only the video image of a player selected by the input device is displayed. In addition, only the video image of a player who satisfies (for example, a player whose bet amount reaches a predetermined amount) a predetermined condition may be configured to be displayed. In other words, selection of one or more players whose videos are displayed on the player display 80 may be appropriately determined.

In the example shown in FIG. 7, the sizes of the ten player display sections are the same. However, according to the present invention, the sizes of the display sections of the players, that is, the sizes of the video images of the players are not required to be the same from one another. For example, the video image of the player selected by the above-described input device, the player who satisfies the predetermined condition, or the like may be configured to be displayed in an enlarged size. The sizes of the video images of the players may be changed on the basis of the bet amounts or game history of the players. In other words, the sizes of ten player display sections may be designed to be appropriately different from one another in accordance with the situation of the game.

In the embodiment, the player display 80 is configured to include ten player display sections in correspondence with the number of stations 3. However, according to the present invention, the player display 80 may include nine or less player display sections. When the camera 81 has functions for record and reproduction and the player display is designed such that the videos of other players can be appropriately recorded and reproduced by the operation of a player playing the game using the station 3 including the player display 80 even in a case where the player display 80 is constituted by nine or less player display sections, the player playing the game using the station 3 including the player display 80 can recognize facial expressions of all the other players.

Next, the internal configuration of the game system 1 will be described.

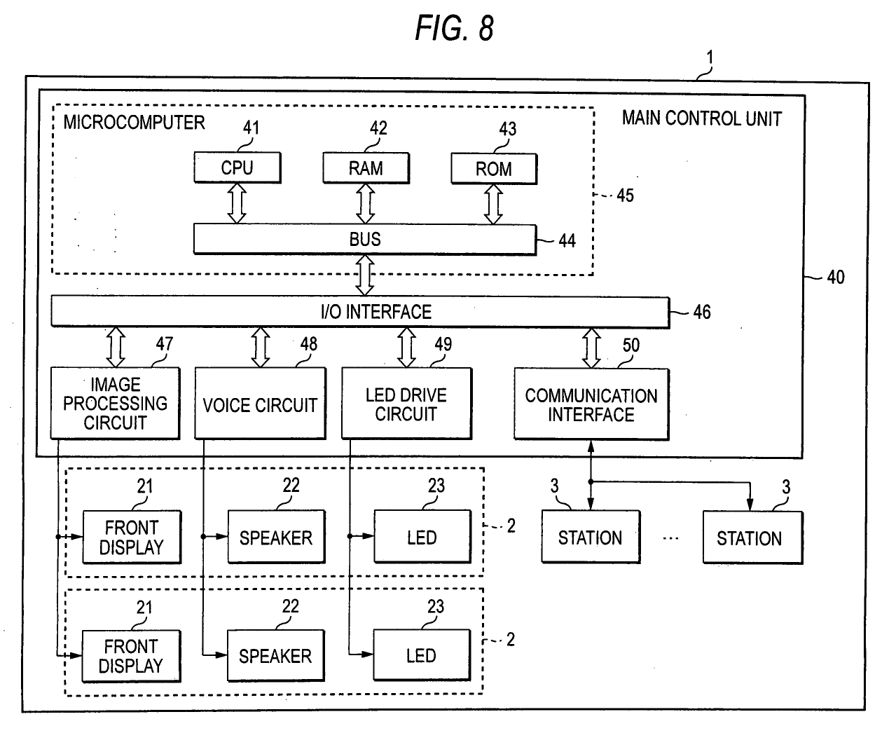

FIG. 8 is a block diagram showing the internal configuration of the game system according to the embodiment.

As shown in FIG. 8, the game system 1 has a main control unit 40, a plurality of stations 3 connected to the main control unit 40, and two main displays 2.

The main control unit 40 includes a microcomputer 45 basically having a CPU 41, a RAM 42, a ROM 43, and a bus 44 for data transmission therebetween, as a core component.

In the ROM 43, various programs, data tables, and the like for performing processes required for controlling the game system 1 are stored. In the embodiment, in the ROM 43, a predetermined number of bets (in the embodiment, 50) is stored. The number of bets becomes a criterion for determining whether to transit to the camera mode to be described later (see Step S131 shown in FIG. 1).

The RAM 42 is a memory for temporarily storing various types of data calculated by the CPU 41.

The CPU 41 is connected to an image processing circuit 47, a voice circuit 48, an LED drive circuit 49, and a communication interface 50 through an I/O interface 46.

The front display 21 is connected to the image processing circuit 47. The speakers 22 are connected to the voice circuit 48. The LEDs 23 are connected to the LED drive circuit 49. Ten stations 3 are connected to the communication interface 50.

The main control unit 40 also performs operations for outputting an image signal to be displayed on the front display 21 and controlling drive of the speakers 22 and LEDs 23.

Next, the internal configuration of the station 3 will be described.

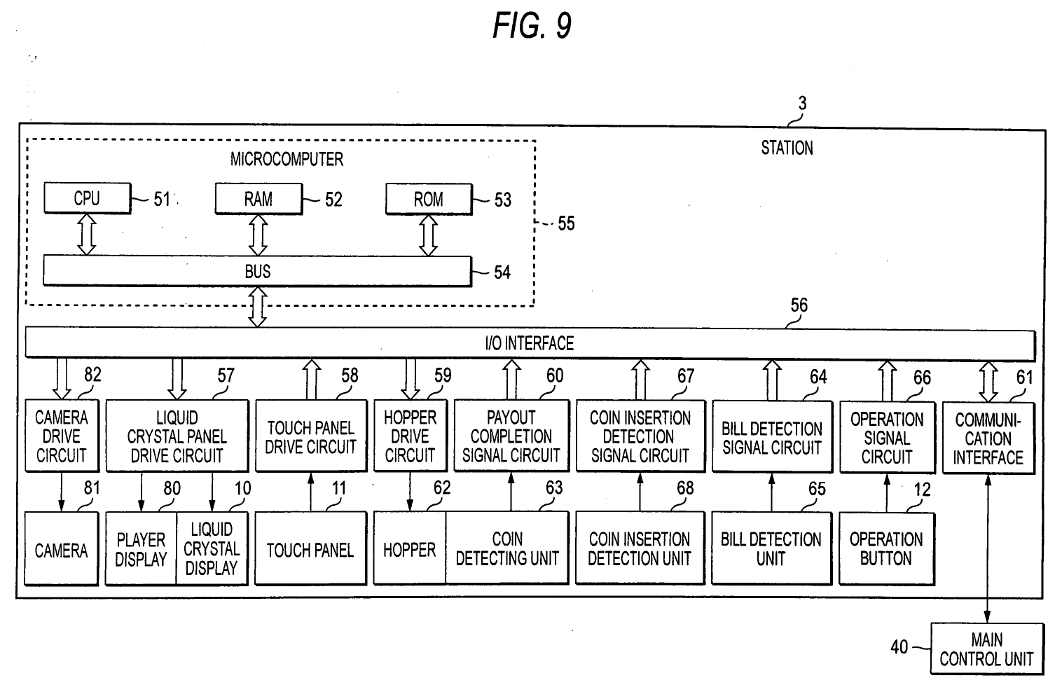

FIG. 9 is a block diagram showing the internal configuration of the station according to the embodiment.

As shown in FIG. 9, the station 3 includes a microcomputer 55 basically having a CPU 51, a RAM 52, a ROM 53, and a bus 54 for data transmission therebetween, as a core component.

In the ROM 53, various programs, data tables, and the like required for performing processes of controlling the station 3 are stored. The RAM 52 is a memory for temporarily storing the number of credits currently stored in the station 3 or various types of data calculated by the CPU 51.

The CPU 51 is connected to a liquid crystal panel drive circuit 57, a touch panel drive circuit 58, a hopper drive circuit 59, a payout completion signal circuit 60, a coin insertion detection signal circuit 67, a bill detection signal circuit 64, an operation signal circuit 66, a communication interface 61, and a camera driving circuit 82, through an I/O interface 56.

A liquid crystal display 10 and a player display 80 are connected to the LCD drive circuit 57. A touch panel 11 is connected to the touch panel drive circuit 58. A hopper 62 is connected to the hopper drive circuit 59. A coin detecting unit 63 is connected to the payout completion signal circuit 60. A coin insertion detecting unit 68 is connected to the coin insertion detection signal circuit 67. A bill detecting unit 65 is connected to the bill detection signal circuit 64. An operation button 12 is connected to the operation signal circuit 66. A camera 81 is connected to the camera driving circuit 82.

The hopper 62 is disposed inside the station 3 and pays out coins from the coin payout opening 15 on the basis of a control signal output from the CPU 51.

The coin detecting unit 63 is disposed inside the coin payout opening 15. When detecting payout of a predetermined number of coins from the coin payout opening 15, the coin detecting unit 63 transmits a signal to the CPU 51.

When detecting insertion of a coin into the coin insertion slot 13, the coin insertion detecting unit 68 detects the amount of the coin and transmits a detection signal indicating the detected amount to the CPU 51.

When receiving a bill, the bill detecting unit 65 detects the amount of the bill and transmits a detection signal indicating the detected amount to the CPU 51.

The operation button 12 is used for performing a payout operation in a case where payout of coins is determined.

Next, a process performed in the game system 1 will be described.

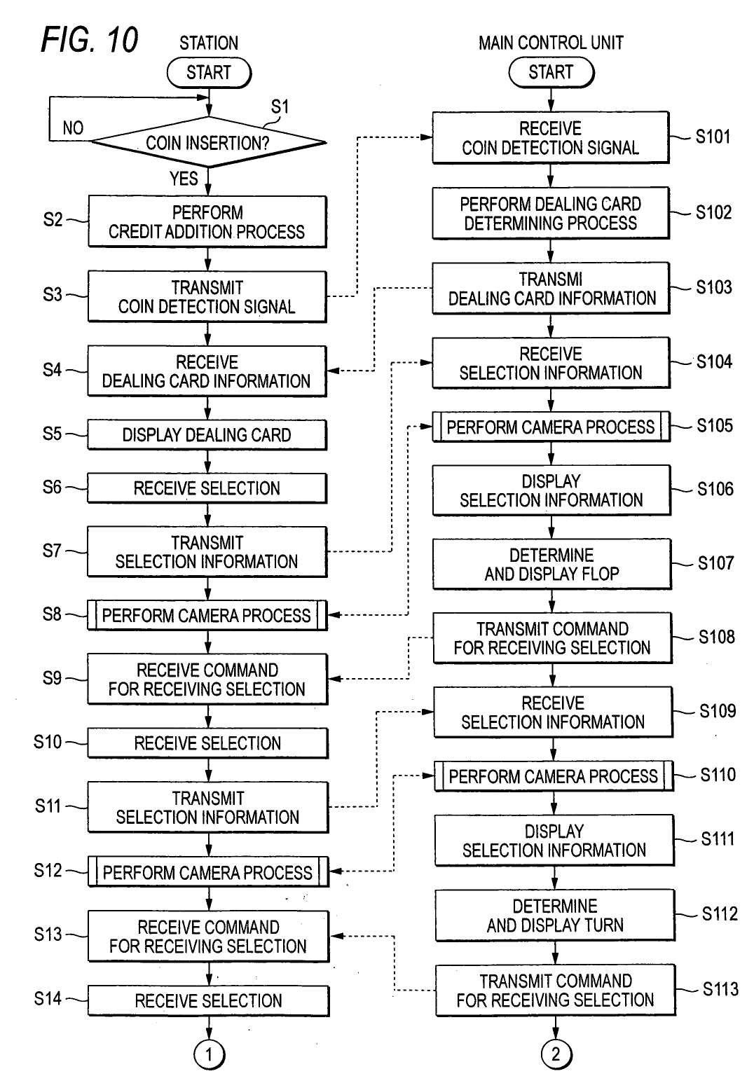

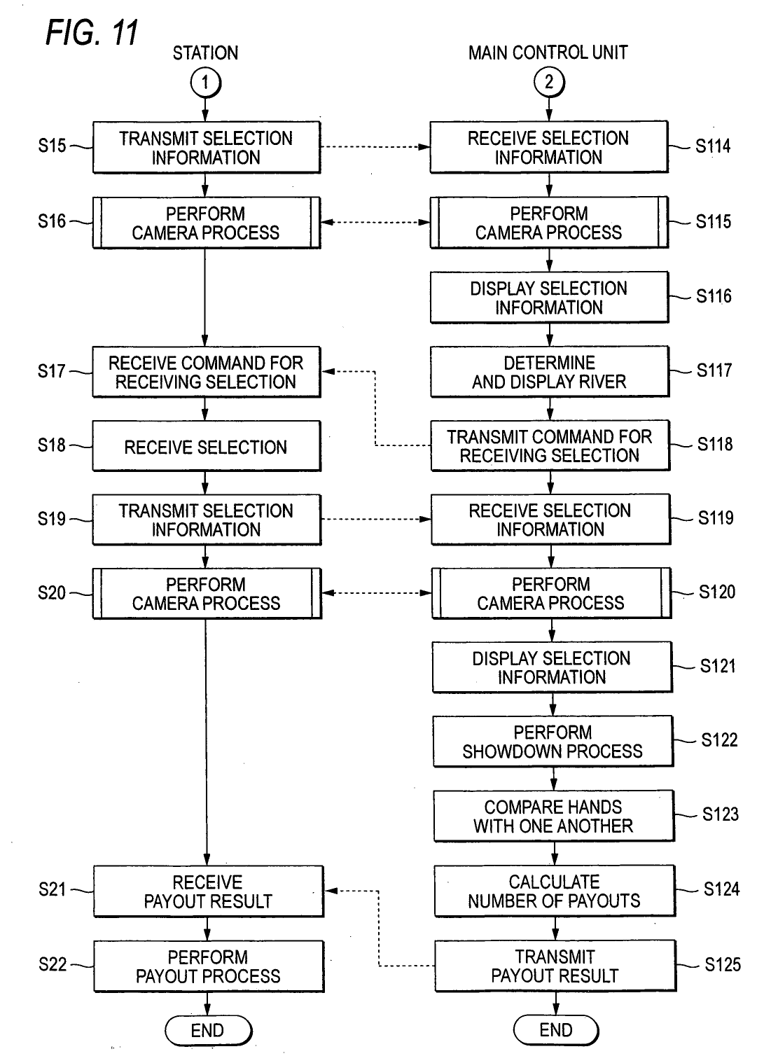

FIGS. 10 and 11 are flowcharts showing a game process according to the embodiment.

First, a process performed in each station 3 will be described.

In Step S1 shown in FIG. 10, the CPU 51 determines whether a coin is inserted by a player. When it is determined that a coin has not been inserted, the process proceeds back to Step S1. On the other hand, when it is determined that a coin has been inserted, the CPU 51 adds credits corresponding to the inserted coin to the credits stored in the RAM 52, in Step S2.

In Step S3, the CPU 51 transmits a coin detection signal to the CPU 41 of the main control unit 40.

In Step S4, the CPU 51 receives dealing card information, which is information on two cards dealt to the player, from the CPU 41 of the main control unit 40. The dealing card information includes numbers, alphabets, and marks.

In Step S5, the CPU 51 displays the two cards on the liquid crystal display 10 on the basis of the dealing card information received in Step S4 (see FIG. 6).

In Step S6, the CPU 51 receives a bet selection. In this step, the player performs the bet selection on the touch panel 11.

In Step S7, the CPU 51 transmits information (hereinafter, also referred to as selection information) on the bet selection input by the player to the CPU 41.

Next, in Step S8, the CPU 51 performs a camera process. This camera process will be described later with reference to FIG. 1.

In Step S9, the CPU 51 receives a direction signal for receiving a bet selection from the CPU 41.

Thereafter, since the processes of Steps S10 to S13 and the processes of Steps S14 to Step S17 shown in FIG. 11 are the same processes of Steps S6 to S9, a description thereof is omitted here.

Next, in Step S18 shown in FIG. 11, the CPU 51 receives a bet selection. Then, in Step S19, the CPU 51 transmits the selection information input by the player to the CPU 41.

Next, in Step S20, the CPU 51 performs the camera process that is the same process as that of Step S8.

Then, in Step S21, the CPU 51 receives the result (hereinafter, also referred to as a payout result) of calculation of the number of payouts from the CPU 41.

In Step S22, the CPU 51 pays out credits on the basis of the payout result received in Step S21.

In particular, the CPU 51 stores the number of total credits bet by the players during the game in the RAM 52. Then, when the operation button 12 is pressed, the CPU 51 pays out coins corresponding to the number of credits stored in the RAM 52 from the coin payout opening 15.

After the process of Step S22 is performed, the game process is completed.

Next, a process performed by the main control unit 40 will be described.

In Step S101, the CPU 41 receives a coin detection signal from the CPU 51 of the station 3.

In Step S102, the CPU 41 determines two cards to be dealt to each player by using random numbers.

In Step S103, the CPU 41 transmits information on the cards determined in Step S102 to the CPU 51.

Then, in Step S104, the CPU 41 receives the selection information from the CPU 51.

Then, in Step S105, the CPU 41 performs a camera process. The camera process will be described later in detail with reference to FIG. 1.

Then, in Step S106, the CPU 41 displays the selection information received in Step S104 in the game information display section 35 (see FIG. 5) of the front display 21.

In Step S107, the CPU 41 determines three cards by using random numbers and displays the determined cards as Flop on the table 31 of the front display 21.

In Step S108, the CPU 41 transmits a signal for requesting to receive a bet selection to the CPU 51.

In Step S109, the CPU 41 receives the selection information from the CPU 51.

Then, in Step S110, the CPU 41 performs the camera process as same as that of Step S105.

In Step S111, the CPU 41 displays the selection information received in Step S109 in the game information display section 35 of the front display 21. Then, in Step S112, the CPU 41 determines one card by using a random number and displays the determined card as Turn on the table 31 of the front display 21.

Since the following processes of Steps S113 to S116 shown in FIG. 11 are the same as those of Steps S108 to S111, a description thereof is omitted here.

In Step S117 shown in FIG. 11, the CPU 41 determines one card by using a random number and displays the determined card as River on the table 31 of the front display 21.

Since the following processes of Steps S118 to S121 are the same as those of Steps S108 to S111, a description thereof is omitted here.

In Step S122, the CPU 41 performs a Showdown process.

In particular, the CPU 41 displays each two cards that have been dealt to a player using each station 3 in the game information display section 35 corresponding to the station 3.

In Step S123, the CPU 41 compares the hands with one another.

In particular, first, the CPU 41 determines a strongest hand among hands made by combining two cards dealt to one player and three cards among five cards displayed on the table 31 of the front display 21 as the hand of the player. After the same process as that described above is performed for all the players remaining in the game, the CPU 41 compares the hands of the players to one another and determines a player whose hand is the strongest.

Next, in Step S124, the CPU 41 calculates the number of payouts.

In particular, the CPU 41 calculates the total credits bet during the game.

In Step S125, the CPU 41 transmits the payout result acquired in Step S124 to the CPU 51.

After performing the process of Step S125, the CPU 41 completes the game process.

As described above, in the embodiment, the camera process in the station 3 is configured to be performed (Steps S8, S12, S16, and S20) after the selection information is transmitted, and the camera process in the main control unit 40 is configured to be performed (Steps S105, S110, S115, and S120) after the selection information is received. However, according to the present invention, timings for performing the camera process is not limited thereto and may be appropriately changed.

In the flowchart shown in FIGS. 10 and 11, the station 3 and the main control unit 40 have been described to have one to one correspondence. As shown in FIGS. 2 and 3, in the embodiment, there are ten stations 3. In the ten stations, a game progresses as below. Here, a game is played by using the ten stations 3, and the process will be briefly described with a focus on the bet selection performed by the players. In the embodiment, the bet selection proceeds in the sequence of stations 3a, 3b, . . . , and 3j.

When a game is started, first, two cards are dealt to a player (hereinafter, also referred to as a player “a”, and similarly players playing the game by using the stations 3b to 3j are also referred to as players “b” to “j”) playing the game by using the station 3a, and the player “a” performs a first bet selection. Then, in the stations 3b to 3j, operations for dealing cards to the players and first bet selections by the players are sequentially performed. A series of the bet selections performed here by the players is “Turn of Dealing”.

Thereafter, when the determination and display of Flop is performed, the players “a” to “j” sequentially perform second bet selections. A series of the bet selections performed here by the players is “Turn of Flop”.

Thereafter, when the determination and display of Turn is performed, the players “a” to “j” sequentially perform third bet selections. A series of the bet selections performed here by the players is “Turn of Turn”.

Thereafter, when the determination and display of River is performed, the players “a” to “j” sequentially perform fourth bet selections. A series of the bet selections performed here by the players is “Turn of River”.

As described above, the game progresses through the stages of “Turn of Dealing”, “Turn of Flop”, “Turn of Turn”, and “Turn of River”.

Now, the camera processes performed in Steps S8, S12, S16, and S20, shown in FIGS. 10 and 11, by the CPU 51 and the camera processes performed in Steps S105, S110, S115, and S120 by the CPU 41 will be described in detail with reference to FIG. 1. As described below, the main control unit 40 and the microcomputer 55 cooperatively serve as a controller according to the present invention.

First, the process performed by the main control unit 40 will now be described.

In Step S131, the CPU 41 determines whether the number of bets (the bet amount) placed in the station 3, which has transmitted selection information, during one game reaches a predetermined number (50 in the embodiment, and the bet amount) stored in the ROM 43 on the basis of the selection information received in Steps S104, S109, S114, or S119 shown in FIG. 10 or 11. When it is determined that the predetermined number has been reached (Step S131: YES), the CPU 41 proceeds to Step S132.

In Step S132, the CPU 41 transmits camera mode transition signals to the CPUs 51 of all the stations 3 (except for the station 3 used by a player who has selected a fold) in which the game is played. A camera mode transition signal indicates a signal for requesting to transit to the camera mode. The camera mode indicates a state in which capturing image of a player is performed by the camera 81 and the video of the captured image of the player is displayed in the player display 80.

In Step S133, the CPU 41 receives information on the player's videos which is transmitted from the CPUs 51 of the stations 3 in Step S33, to be described later.

Next, in Step S134, the CPU 41 transmits the CPUs 51 of all the stations 3 (excluding a station 3 used by a player who has selected a fold) information (in the figure, video data of other players) on video images of players captured by stations other than each corresponding station.

When it is determined that the predetermined number has not been reached (Step S131: NO) in Step S131 or after the process of Step S134 is performed, the CPU 41 completes this subroutine.

Next, the process performed by each station 3 will be described.

First, in Step S31, the CPU 51 of each station 3 determines whether the camera mode transition signal transmitted by the CPU 41 in Step S132 has been received. When it is determined that the camera mode transition signal has been received (Step S31: YES), the CPU 51 proceeds to Step S32.

In Step S32, the CPU 51 of each station 3 performs an operation for capturing an image of a player by using the camera 81.

Next, in Step S33, the CPU 51 of each station 3 transmits the information (in the figure, the video data) on the video image of the player captured in Step S32 to the CPU 41.

In Step S34, the CPU 51 of each station 3 receives information on the video data of other players which has been transmitted by the CPU 41 in Step S134, that is, information on the video images of players 3 captured by stations 3 other than the corresponding station 3.

Next, in Step S35, the CPU 51 of each station 3 displays the video images of the players captured by stations 3 other than the station 3 in the player display 80 on the basis of the video data of other players received in Step S34.

In the embodiment, in a station 3 used by a user who has selected a fold, the operation for capturing image of the player by the camera 81 and the operation for displaying the captured video image in the player display 80 are not performed. However, the present invention is not limited thereto. In other words, in a station 3 used by a user who has selected a fold, the operation for capturing image of the player by the camera 81 and/or the operation for displaying the captured video image in the player display 80 may be configured to be performed.

In the embodiment, when there is not a station 3 (including a station 3 used by a player who has selected a fold) in which the game is not played, videos of nine players are displayed on the player display 80. In other words, in one player display section (one player display section corresponding to one station 3) from among the ten player display sections, the video image of a player is not displayed.

In the embodiment, in the one player display section corresponding to the one station 3, the game information of a player playing the game by using the station 3 is displayed (see FIG. 7).

However, the present invention is not limited thereto. For example, in the one display section corresponding to the one station 3, the video image of a player playing the game by using the station may be configured to be displayed, or the game information or video image of a player who has a turn to perform a bet selection may be configured to be displayed. The game information or video of any player may be configured to be displayed in accordance with selection the player playing the game by using the station 3, or the game information or video of a randomly determined player may be configured to be displayed. In other words, the one player display section corresponding to the one station 3 may be designed so as to appropriately display the game information, the video image of a player, or the like. Furthermore, in the one player display section corresponding to the one station 3 in which the game is played, the image of a dealer may be configured to be displayed, or nothing may be displayed. The content of display may be appropriately shifted by an operation of a player playing the game by using the station 3. In other words, whether an image is displayed in the one player display section corresponding to the one station 3 in which the game is played, and which image is displayed in a case where an image is determined to be displayed may be appropriately changed.

On the other hand, when there is a station 3 (including a station 3 used by a player who has selected a fold) which is not used for the game, in a player display section corresponding to the station 3 that is not used for the game, the video image of a player is not displayed.

In such a case, according to the embodiment, the image of a dealer is displayed. However, the present invention is not limited thereto. For example, the game information or video image of a player playing the game by using the station 3 including the player display section, a player who has a turn to perform a bet selection, or the like may be configured to be displayed therein. Alternatively, the game information or video of any player may be displayed therein on the basis of a selection of a specific player such as a player playing the game by using the station 3 or a player having the largest number of bets. Furthermore, the game information or video of a randomly determined player may be configured to be displayed therein or nothing may be displayed therein. The content of display may be appropriately shifted by an operation of a player playing the game by using the station 3. In other words, when there is a station 3 (including a station 3 used by a player who has selected a fold) which is not used for the game, in a player display section corresponding to the station 3 that is not used for the game, whether an image is displayed, and which image is displayed in a case where an image is determined to be displayed may be appropriately changed.

In the embodiment, once the image capturing operation using the camera 81 and the display on the player display 80 are performed in a game, the image capturing operation and the display are configured to be continued until the game is completed. However, the present invention is not limited thereto. For example, the image capturing operation and the display operation may be configured to be performed only for a predetermined time. In such a case, by configuring the camera 81 to have functions for record and reproduction and designing the camera such that the video images of players other than a player playing the game by using the station 3 having the player display 80 can be appropriately recorded and reproduced by the operation of the player, the image capturing operation and the display is performed only for a predetermined time and the player can view a desired video repeatedly. Even when it is designed that the image capturing operation is continued until the game is completed, it is possible to include functions for record and reproduction in the camera 81 and to design the camera such that the displayed video can be appropriately shifted so as to enable a player to view any video from among the continuously captured video and the recorded videos.

When it is determined that a camera mode transition signal has not been received in Step S31 (Step S31: NO) or after the process of Step S35 is performed, the CPU 51 completes this subroutine.

As described above, the camera process has been described with reference to FIG. 1. In the embodiment, a condition that the bet amount placed during one game in one station 3 reaches a predetermined upper limit (50) is set as a trigger (hereinafter, also referred to as a trigger condition) for transition to the camera mode. However, according to the present invention, the upper limit for the trigger condition may be appropriately changed. The upper limit of the bet amount may be set in advance by a manufacturer of the game system or a supervisor of a game arcade where the game system is installed. When the supervisor of the game arcade is to set the upper limit of the bet amount, a setting switch may be provided.

In addition, according to the present invention, the upper limit of the bet amount for the trigger condition is not limited to a predetermined value. For example, in a game, when a player places a bet of which amount exceeds the maximum bet amount placed by the player in former games, transition to the camera mode may be made. In a game, when a player places a bet of which amount exceeds the maximum bet amount placed by any one of other players in former games, the transition to the camera mode may be made. In other words, the upper limit of the bet amount for the trigger condition may be changed in accordance with progress of the game.

According to the present invention, the bet amount for the trigger condition is not limited to a bet amount placed in one game. For example, the bet amount for the trigger condition may be a total bet amount of each player since the player starts a game or a total bet amount of several games (for example, five games) prior to a game. In other words, the bet amount for the trigger condition may be determined on the basis of games prior to a game along with one game.

In addition, according to the present invention, whether the trigger condition is satisfied may be determined with reference to the game information other than the bet amount. For example, when dealer's cards satisfy a predetermined strong combination (for example, when there appears a card of a same number a predetermined number of times or more), the transition to the camera mode may be made. In addition, when a predetermined number of players (for example, five players) or more have combinations stronger than a predetermined combination (for example, Straight or higher), the transition to the camera mode may be made. In addition, when there is a “Rich” on a predetermined combination (for example the combination is randomly changed for each game) in a plurality of players, the transition to the camera mode may be made. In addition, for example, when there is a big change in the ranking of the players in accordance with a card of the dealer appearing in the next round, the transition to the camera mode may be made.

As described above, according to the present invention, the trigger condition is not particularly limited to a condition, as long as the condition is on the basis of a situation, which can encourage the game, such as a situation in which a predetermined strong hand can be made, a situation in which a combination equal to or higher than a predetermined combination is determined to be made, a situation in which a close contest is made among a plurality of players, or the like.

In the embodiment, after the fourth bet selections of all the players are completed, a camera process is configured to be performed (Steps S20 and S120). However, according to the present invention, the camera processes of Steps S20 and S120 may be configured not to be performed.

The embodiment has been described with reference to the drawings. The game system 1 according to the embodiment includes two main displays 2 installed such that two front displays 21 of the main displays 2 are disposed to be back to back. The game system 1 includes ten stations 3 installed so as to surround two main displays 2, so that one front display 21 between the two front displays 21 can be visually recognized.

In the embodiment, although an image displayed on one front display 21 between the front displays 21 of two main displays 2 is configured to be the same as an image displayed on the other front display 21, according to the present invention, the method of displaying images on the display screens is not limited thereto.

For example, it may be configured that different images are displayed on two display screens in accordance with the progress of a game. An example of an embodiment having such a configuration is shown as below.

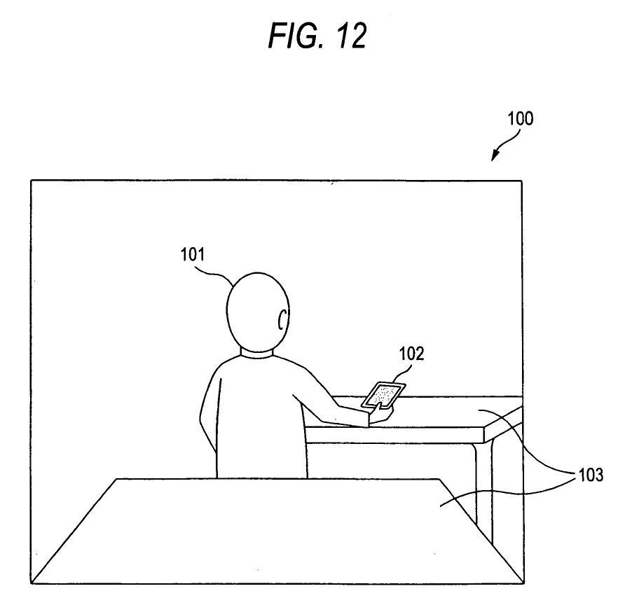

FIG. 12 is a diagram showing an example of an image displayed on a front display included in a game system.

As shown in FIG. 12, in an approximate center of a front display 100 according to the embodiment, a dealer 101 having a card 102 in his right hand with his back turned back is displayed. In front and rear of the dealer 101, tables 103 are displayed. FIG. 12 shows a state that the dealer 101 deals a card 102 to a player located on the side of a different front display 100 disposed to be back to back with the front display 100. At this moment, in the different front display 100 disposed back to back with the front display 100, a dealer dealing a card is displayed while facing a player up to receive the dealing card.

As described above, in the embodiment, although the game system 1 is configured to include two main displays 2 disposed to be in a state that two front displays 21 are disposed in back-to-back arrangement, the main displays 2 included in the game system 1 is not limited thereto. For example, only one main display 2 may be disposed. Hereinafter, another example will be described.

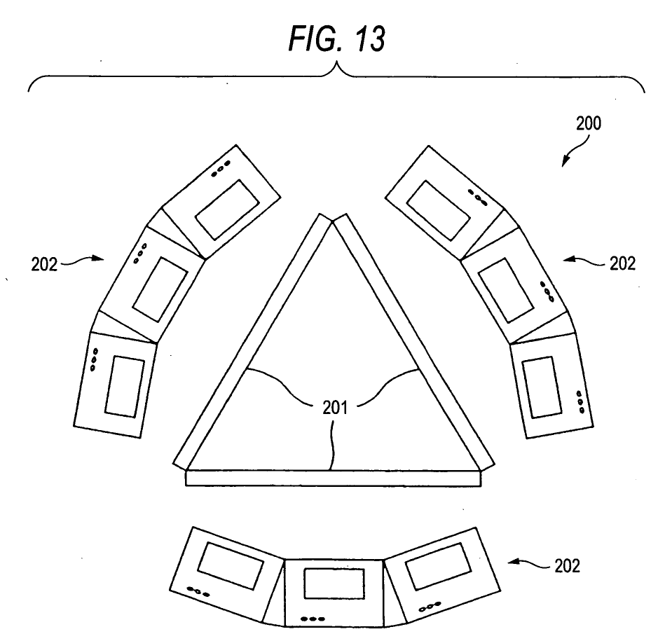

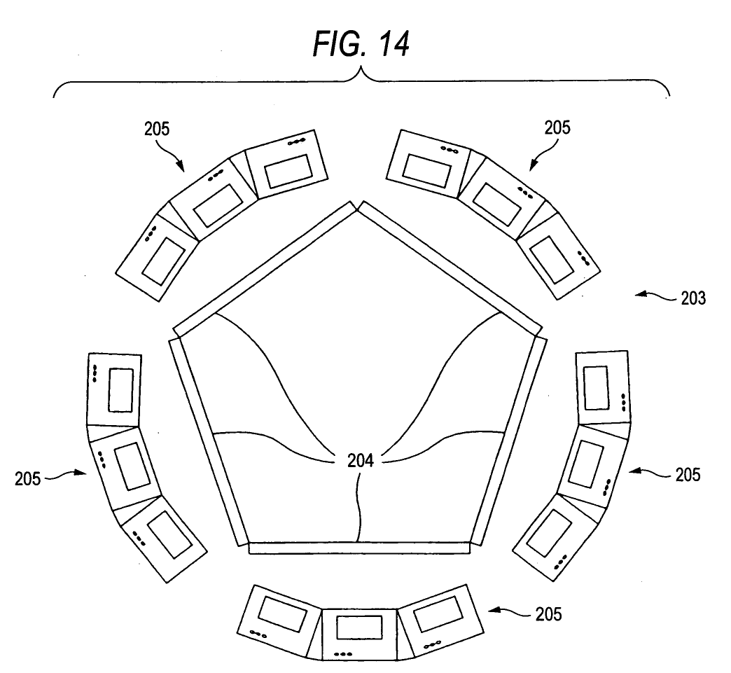

FIGS. 13 and 14 are top views showing examples of the game system.

In the game system 200 shown in FIG. 13, three flat main displays 201 are disposed to form a triangle top view. In addition, station units 202 are disposed to surround the three flat main displays 201.

In the game system 203 shown in FIG. 14, five flat main displays 204 are disposed to form a pentagon top view. In addition, station units 205 are disposed to surround the five flat main displays 204.

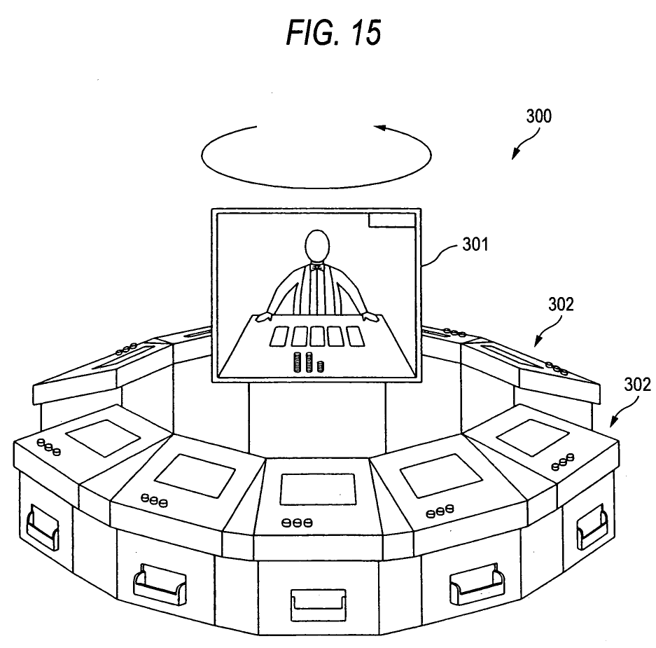

FIG. 15 is a perspective view showing an example of the game system.

As shown in FIG. 15, the game system 300 includes a main display 301 disposed to be rotatable in a horizontal direction with respect to the floor and station units 302 disposed to surround the main display 301.

The main display 301 rotates in a counterclockwise direction (see an arrow shown in FIG. 15) viewed from the top. The main display 301 is controlled to be stopped in a range in which, when one player is up to receive a dealing card or perform a bet selection, the player can view the display screen of the main display 301 on the front side.

In the embodiment, although an example in which the main display 301 is controlled to be stopped toward a player who has a turn to receive a dealing card or perform a bet selection has been described, according to the present invention, the method of controlling rotation of the main display is not limited thereto.

For example, the main display may be controlled to be stopped toward a player who inputs a command. Alternatively, for example, the main display may be configured to continuously rotate at a constant speed.

Although the main display 301 is configured to rotate in a counterclockwise direction according to the embodiment, according to a third embodiment, the rotation direction of the main display is not limited thereto.

For example, the main display may be configured to rotate in a clockwise direction and may be determined to rotate in a clockwise direction or a counterclockwise direction depending on the rotation angle of a next stop position.

In the above-described embodiment, although main displays 2 having flat display screens are used, however, the display screens of the main displays 2 are not limited to a flat type. For example, the display screens may be a convex type.

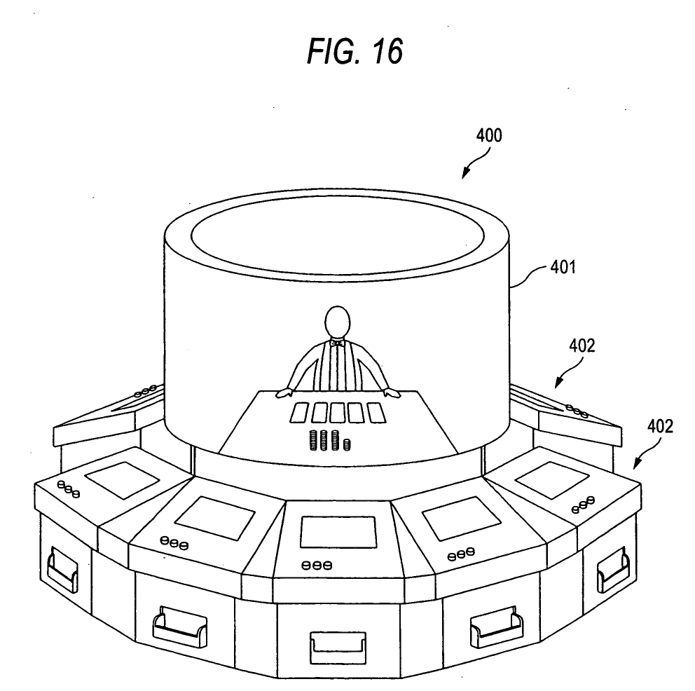

FIG. 16 is a perspective view showing an example of the game system.

As shown in FIG. 16, the game system 400 includes a cylindrical main display 401 and station units 402 disposed to surround the main display 401.

In the game system 400, the image displayed on the display screen of the main display 401 is controlled to move horizontally with respect to the floor on the display screen and to be stopped in a range in which a player can view the image on the front side at a time when the player is up to receive a dealing card or perform a bet selection.

However, the method of controlling the display of the image according to the present invention is not limited thereto. For example, the display screen may be divided into a plurality of portions and images may be displayed on each portion.

The shape of the main display according to the present invention is not limited to a perfect cylinder. For example, the main display may have a donut-like shape, and a plane may be included in a part of the cylinder.

In the above-described embodiments, although a common image that can be viewed by a plurality of players is configured to be displayed on the display screen of the main display, the method of displaying the image according to the present invention is not limited thereto. For example, the image may be projected on a screen by using a projector.

In the above-described embodiments, although the stations are disposed to surround the main display, the position of the stations according to the present invention is not limited to a particular position as long as the display screen of the main display located in the position can be visually recognized.

Although a case where the game performed by the game system is Hold'em Poker has been described in the above-described embodiments, the game performed by the game system is not limited to a specific game as long as the game is played by a plurality of players while a common screen is viewed.

As described above with reference to the embodiments, there is provided a game system in which, when a predetermined condition (for example, the bet amount reaches a predetermined amount or the like) is satisfied in a game played by a player operating one of the input devices, all the players who operate the input devices are captured by using the camera. In each display in which the game is played, at least video images of players other than a player who operates an input device corresponding to the each display are displayed.

Accordingly, when the predetermined condition is satisfied in a game played by a player, all the players can naturally acquire other players' facial expressions and the like in an easy manner.

In addition, by configuring the game system such that all the players can acquire other players' facial expressions and the like only when the predetermined condition is satisfied in a game played by a player, each player's facial expression cannot be continuously observed by other players. Accordingly, a period during which the players can play the game with little concern over other player's viewing him can be provided. Generally, when a card game is played by using real cards, each player can notice whether any other player views him from the player's sight and, the like. However, when a configuration in which video images of players captured by a camera are viewed from a display is used, each player cannot notice whether any other player views him from the player's sight and the like, and thus a player may have a feeling that other players continuously view him, and thereby there is a possibility that the player cannot concentrate on the game. However, according to the present invention of “(1)”, a period during which each player can play the game with little concern about other player's viewing him, and accordingly, it is possible to prevent each player from having a feeling that other players continuously view him.

There is also provided a game system in which, when a predetermined condition (for example, the bet amount reaches a predetermined amount or the like) is satisfied in a station in which a player plays a game, an image capturing operation by using the camera included in station in which the game is played is performed, and in the display of each station in which the game is played, at least image captured in stations other than the each station are displayed. Accordingly, when the predetermined condition is satisfied in a game played by a player, all the players can naturally acquire other players' facial expressions and the like in an easy manner.

In addition, as described above, by configuring the game system such that all the players can acquire other players' facial expressions and the like only when the predetermined condition is satisfied in a game played by a player, each player's facial expression cannot be continuously observed by other players. Accordingly, a period during which the players can play the game with little concern over other player's viewing him can be provided. Accordingly, it is possible to prevent each player from having a feeling that other players continuously view him.

There is also provided a game system in which, when a bet amount for one game in a station in which a player plays a game reaches a predetermined amount, an image capturing operation by using the camera of a station in which the game is played is performed. In each station in which the game is played, image captured in stations other than the each station are displayed. Accordingly, when the bet amount reaches a predetermined amount in a game played by a player, all the players can naturally acquire other players' facial expressions and the like in an easy manner.

In addition, as described above, by configuring the game system such that all the players can acquire other players' facial expressions and the like only when the predetermined condition is satisfied in a game played by a player, each player's facial expression cannot be continuously observed by other players. Accordingly, a period during which the players can play the game with little concern over other player's viewing him can be provided. Accordingly, it is possible to prevent each player from having a feeling that other players continuously view him.

There is provided a game system having a new entertaining feature that enables each player to easily acquire other players' facial expressions in a natural manner.

While the embodiments of the present invention have been described as above, the embodiments are merely detailed examples of the present invention, and therefore the present invention is not particularly limited thereto, and the design of detailed configurations of each means and the like may be changed appropriately. The advantages described in the embodiments of the present invention are merely examples of appropriate advantages that are generated from the present invention, and therefore the advantages of the present invention are not limited thereto.

In the description of the present invention described above, distinctive features of the present invention have been focused for easy understanding thereof. The present invention is not limited to the embodiments described in the detailed description and may be applied to other embodiments, and the present invention can be applied to various application fields. The terms and expressions used in this specification are not for limiting the interpretation of the present invention but for precisely describing the present invention. It will be understood that those skilled in the art can easily deduce a different configuration, a system, or a method belonging to the concept of the present invention from the concept of the present invention described in this specification. Accordingly, the description of Claims should be considered to include equivalent configurations without departing from the spirit and scope of the present invention. The purpose of the abstract is to enable Patent Trademark Office, general public organizations, or a technical person or the like belonging to the technical field of the present invention who is not familiar with patents, legal terms, or professional terms to acquire the technical contents and essence of the present application in an easy manner by performing a simple research. Accordingly, the abstract is not intended to limit the scope of the present invention which should be determined by Claims. In order to sufficiently understand the object and distinctive advantages of the present invention, it is required to fully refer to disclosed documents and the like.

The above-described detailed description of the present invention includes processes executed by a computer. The purpose of the descriptions and expressions as above is to enable those skilled in the art to efficiently understand the present invention. In this specification, steps used for inducing one result should be understood as processes without self contradiction. In each step, transmission, reception, record, or the like of electric or magnetic signals is performed. In the processes of the steps, although these signals are represented by bits, values, symbols, letters, terms, numbers, or the like, however, it should be considered that those representations are used only for the convenience of descriptions. Although the processes of the steps may have been described as expressions common to human behavior, basically, the processes described in this specification are performed by various apparatuses. In addition, other configurations required to perform the processes in the steps are apparent from the descriptions above.

What is claimed is:

1. A game system that provides a game in which a plurality of players participate, the game system comprising:
at least one camera device that captures facial images of the players;
a plurality of display units that are provided for each of the players and display images related to the game;
a plurality of input devices that are provided for each of the players and allow the respective players to input commands for playing the game; and
a controller that operates to:
control the camera device to capture facial images of all the players currently playing the game, when one of the players satisfies a predetermined condition in the game; and
control all the display units, which are provided for the players currently playing the game, to display at least the facial images of the players other than the player who plays the game with the respective display units.

2. The game system according to claim 1 further comprising a plurality of stations that are respectively provided for each of the players to play the game,
wherein each of the stations is provided with one of the camera device, one of the display units, and one of the input devices.

3. The game system according to claim 2, wherein the controller controls the camera device to capture facial images of all the players currently playing the game, when a bet amount that is bet in a single round of the game in one of the stations reaches a predetermined amount.

4. The game system according to claim 1, wherein each of the input devices is a touch panel that is provided on a screen of each of the display units.
